(19) United States
(12) Patent Application Publication
(10) Pub. No.: US 2025/0337829 A1
(43) Pub. Date: Oct. 30, 2025

(54) STAND AND SHADE FOR MOBILE ELECTRONIC DEVICE

(71) Applicant: Keith Redburn, Bay City, MI (US)

(72) Inventor: Keith Redburn, Bay City, MI (US)

(21) Appl. No.: 19/192,008

(22) Filed: Apr. 28, 2025

Related U.S. Application Data
(60) Provisional application No. 63/639,460, filed on Apr. 26, 2024.

(51) Int. Cl. H04M 1/04; G06F 1/16

(52) U.S. Cl. CPC H04M 1/04; G06F 1/1603

(57) ABSTRACT

A support assembly for a portable electronic device having a screen, such as a mobile telephone, includes a base with surfaces for supporting the electronic device in a generally vertical orientation for ease of viewing. The support assembly further includes a post mounted to the base, and a shade above supported by the post above the base to obstruct direct sunlight from reaching the screen of the electronic device. The base is configured to receive various support implements for supporting the base above the ground, such as a stake, a clip, etc.

### CROSS-REFERENCE TO RELATED APPLICATION

This application claims the benefit of U.S. provisional patent application No. 63/639,460, filed Apr. 26, 2024, and which is hereby incorporated by reference in its entirety.

### TECHNICAL FIELD

This disclosure relates to mobile phone accessories and more particularly to mobile phone holders.

### BACKGROUND

Various portable electronic devices include screens for displaying information. Such devices include, but are not limited to, mobile telephones, personal digital assistants, and digital media players. Portable electronic devices with screens are extremely popular and used by consumers in a variety of conditions. As used herein, “mobile phone,” “mobile telephone,” and “phone” may be used interchangeably and may also include other portable electronic devices.

Mobile phone use outdoors is often desirable because mobile phones not only enable a user to remain in communication with others through calls or text messages, but phones also often include cameras and other functions that a user may want to use. However, phones are vulnerable to damage from excessive heat, water, and contamination from dirt, sand, etc. Furthermore, the screens may not be usable in direct sunlight.

### SUMMARY

A mobile phone stand is provided herein that supports a mobile phone above the ground or other outdoor surface to avoid contamination of the phone by dirt, sand, etc. The mobile phone stand may also include a shade that protects the mobile phone from direct sunlight, thereby preventing excessive heating of the phone while also enhancing visibility of the phone's screen.

According to one embodiment, the mobile phone stand includes a base having a first surface, a second surface, and a portion that is restable on a planar horizontal surface. The first surface is generally horizontal and the second surface is generally vertical when the portion rests on the planar horizontal surface. A post is operatively connected to the base such that the post is generally vertical when the portion rests on the planar horizontal surface. A shade is supported above the base by the post.

The mobile phone stand may also include an interface at which support implements are attachable to the base for use when a horizontal planar surface is not available or desirable. For example, one support implement may be a stake that is insertable into the ground to support the stand and maintain the phone in an elevated position away from dirt, sand, etc. The use of the stake as the support implement for the stand assembly may be especially beneficial for use on a beach.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a side view of a mobile phone stand having a base, a post, and a shade;

FIG. 2 is a side view of the base with a mobile telephone supported thereon;

FIG. 3 is a perspective view of the base;

FIG. 4 is another perspective view of the base;

FIG. 5 is a side view of the post;

FIG. 6 is a front view of the post;

FIG. 7 is a rear view of the base with the post attached thereto;

FIG. 8 is a side view of the base with the post attached thereto;

FIG. 9 is a bottom view of the shade;

FIG. 10 is a side view of the mobile phone stand with the shade in an alternate position relative to the base;

FIG. 11 is a perspective view of a portion of a support implement that is attachable to the base;

FIG. 12 is a side view of the support implement;

FIG. 13 is a side view of a flag holder;

FIG. 14 is a top view of the flag holder;

FIG. 15 is a front view of the mobile phone stand with first and second flag holders mounted to the shade;

FIG. 16 is a side view of the mobile phone stand with a clip mounted thereto and the post in a first position relative to the base;

FIG. 17 is a side view of the mobile phone stand with the support implement of FIGS. 11 and 12 mounted thereto and the post in a second position relative to the base;

FIG. 18 is a side view of a clip;

FIG. 19 is a front view of the clip;

FIG. 20 is a top view of the clip;

FIG. 21 is a perspective view of the mobile phone stand with two of the clips connected to the base; and

FIG. 22 is another perspective view of the mobile phone stand with two of the clips connected to the base.

### DETAILED DESCRIPTION

Referring to the Figures, wherein like reference numbers refer to like components throughout, a phone stand assembly 10 is schematically depicted. The phone stand assembly 10 includes a base 14, a shade 18, and a post 22. The post 22 is mounted to the base 14 and the shade 18 such that the post 14 supports the shade 18 above the base 14 when the assembly 10 is in its use position.

The base 14 in the embodiment depicted includes a first surface 26, a second surface 30, and a portion 34 that is restable on a flat horizontal surface such as, but not limited to, a tabletop. The base 14 is configured such that, when the portion 34 rests on a horizontal surface 38, the first surface 26 is generally horizontal and faces upward and the second surface 30 is generally vertical. More specifically, the first surface 26 is within forty-five degrees of horizontal, and the second surface 30 is within forty-five degrees of vertical.

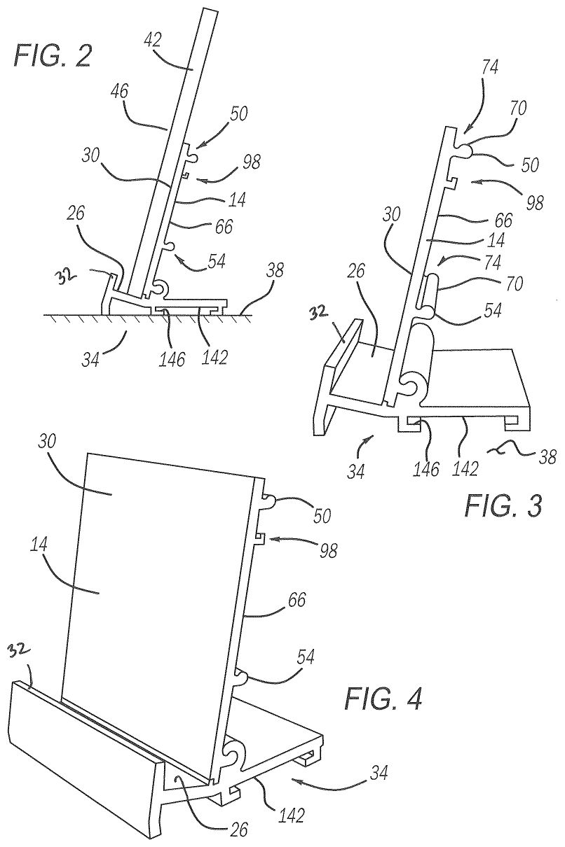

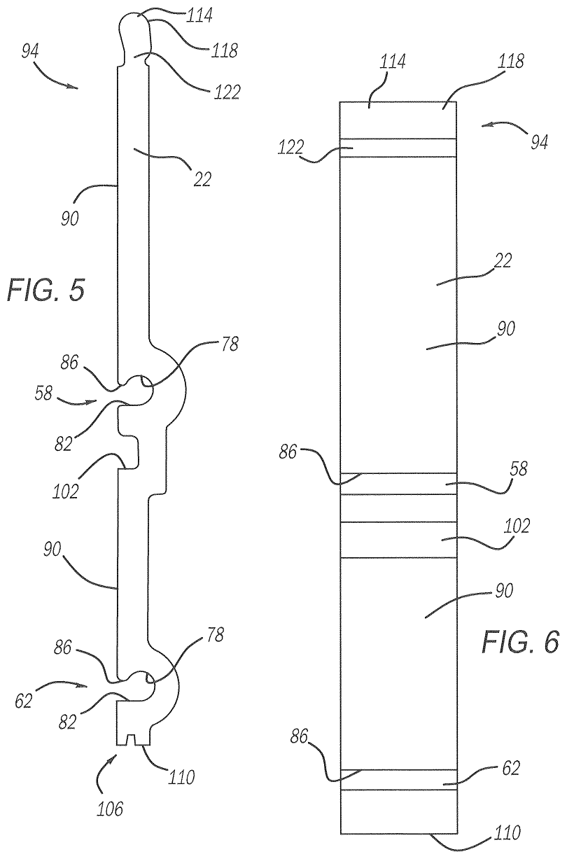

A mobile phone 42 may be placed on the first surface 26 and lean against the second surface 30, as shown in FIG. 2, so that the base 14 separates the phone 42 from any contaminants on the surface 38 and maintains the phone 42 in a position that facilitates use and monitoring by a user (e.g., with the screen 46 upright and generally vertical). The base 14 may also include a lip or flange 32 that protrudes on the opposite side of surface 26 from surface 30 to further retain the phone 42. It should be noted that other configurations for the base 14 may be employed within the scope of the claimed invention.

The base 14 also includes first and second fastening elements 50, 54 that are engageable with third and fourth fastening elements 58, 62 on the post 22. The assembly 10 in the embodiment depicted uses grooves and tongues as fastening elements. In the embodiment depicted, the first and second fastening elements 50, 54 are tongues or protuberances from planar surface 66 that each have a respective wide portion 70 and a respective narrow portion 74. The wide portion 70 is at the distal end of the protuberance and the narrow portion 74 connects the wide portion 70 to surface 66.

In the embodiment depicted, the third and fourth fastening elements 58, 62 are grooves formed within the post 22. Each groove includes a respective wide portion 78 and a respective narrow portion 82. The narrow portion 82 interconnects the wide portion 78 to the opening 86 of the groove at the outer surface 90 of the post 22.

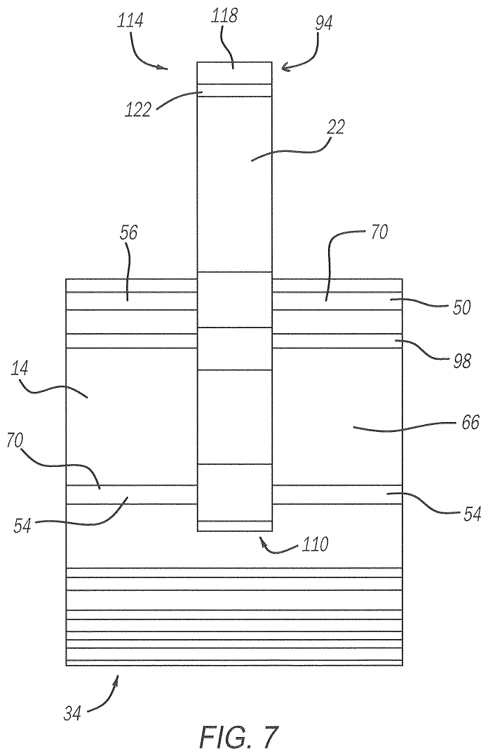

Each protuberance 50, 54 is fittable into any one of the grooves 58, 62 such that the wide portion 70 of the protuberance 50, 54 is within the wide portion 78 of one of the grooves 58, 62 and the narrow portion 74 of the protuberance 50, 54 extends through the narrow portion 82 of one of the grooves 58, 62, as shown in FIGS. 7, 8, 16, and 17.

When a protuberance 50, 54 is within a groove 58, 62, the protuberance is limited in motion to translation in the longitudinal direction of the groove. Further, friction resists such translation, thereby effectively connecting the post 22 to the base 14. The protuberances are insertable into the grooves through the lateral openings of the grooves, and can be removed by applying a force sufficient to overcome the friction and thereby slide the protuberances out the lateral openings of the grooves.

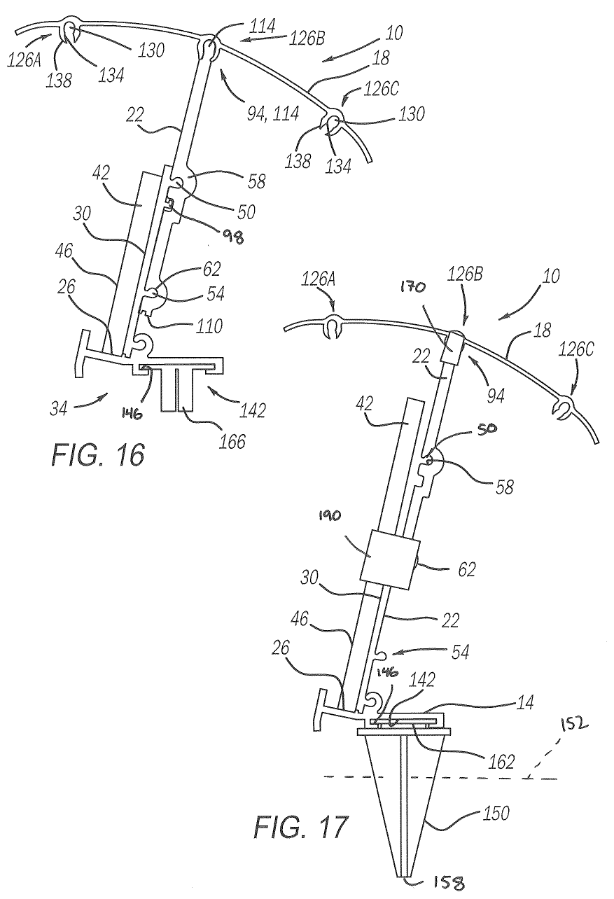

Referring specifically to FIGS. 7 and 16, the post 22 is in a first position relative to the base 14 when the first fastening element 50 is engaged with the third fastening element 58 and the second fastening element 54 is engaged with the fourth fastening element 62. In the first position, the upper end 94 of the post 22 is at a first height above the base 14. It should be noted that the base 14 includes an L-shaped lip 98 that protrudes from surface 66 below the first fastening element 50. One segment of the lip 98 that is proximal to the surface 66 extends perpendicular to the surface 66 and another segment of the lip 98 that is distal to surface 66 is parallel to the surface 66 and thus is generally vertical when the assembly 10 is in a use position such as when the portion 34 rests on a horizontal surface 38. The post 22 defines a concavity 102 that accommodates the lip 98 when the post 22 is in the first position, i.e., the lip 98 is in the concavity 102 when the post 22 is in the first position.

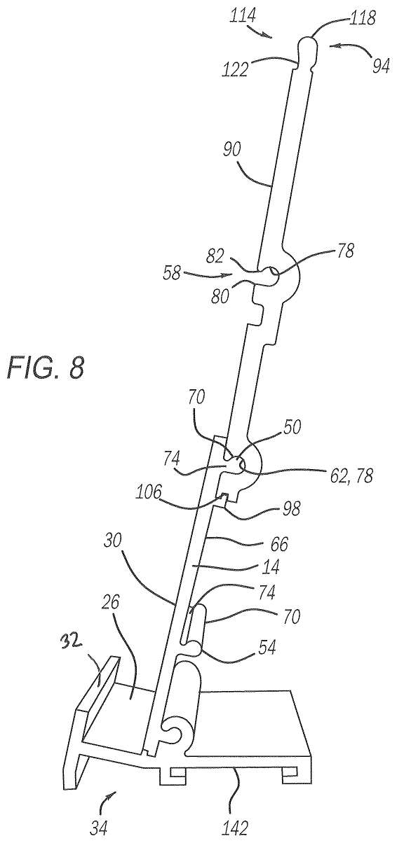

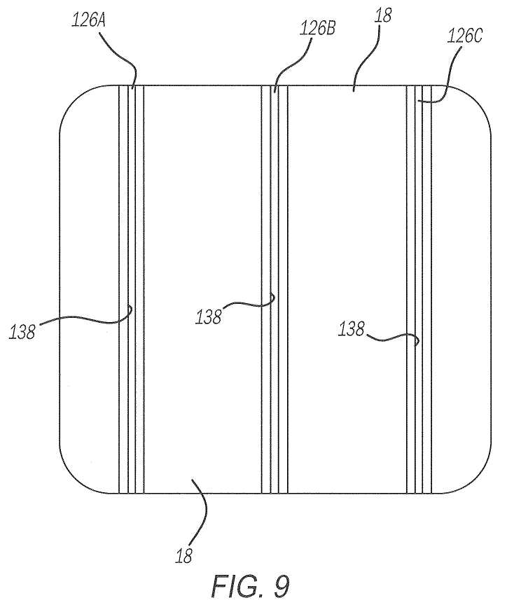

As shown in FIGS. 8 and 17, the post 22 is in a second position relative to the base 14 when the first fastening element 50 is engaged with the fourth fastening element 62, thereby causing the upper end 94 to be higher than in the first position. The shade 18 is mounted to the post 22 at the upper end 94, and therefore the height of the shade 18 above the base 14 is selectively variable.

It should be noted that the post 22 in the embodiment depicted defines a slot 106 at the lower end 110 of the post. When the post 22 is in the second position, the distal segment of the lip 98 extends upward into the slot 106 to provide stability to the post 22.

The post 22 includes a fifth fastening element 114 at the upper end 94. The fifth fastening element 114 in the embodiment depicted is substantially similar or identical to the first and second fastening elements 50, 54. More specifically, the fifth fastening element 114 includes a wide portion 118 connected to the remainder of the post 22 by a narrow portion 122.

The shade 18 has three fastening elements 126A, 126B, 126C that are substantially identical to one another except their position relative to the shade 18. The fifth fastening element 114 is selectively engageable with any one of the three fastening elements 126A, 126B, 126C. More specifically, each element 126A, 126B, 126C is a groove formed in structure of the shade 18; each groove has a wide portion 130 and a narrow portion 134 between the wide portion 130 and an opening 138.

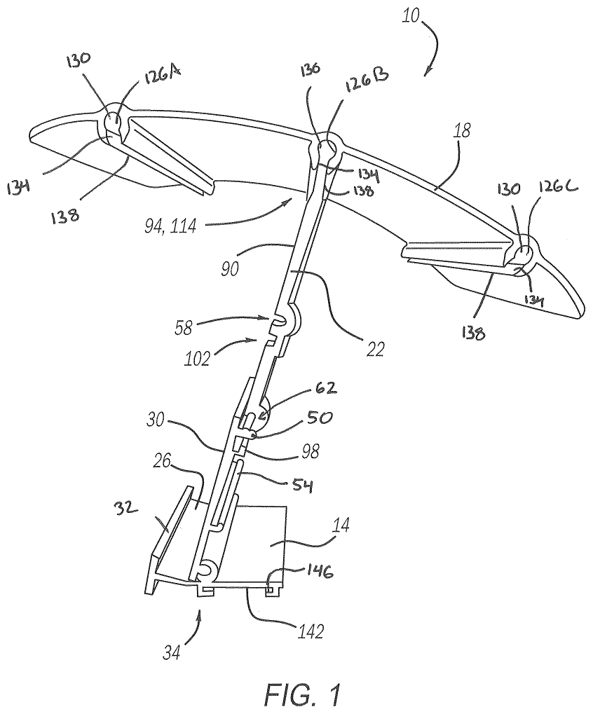

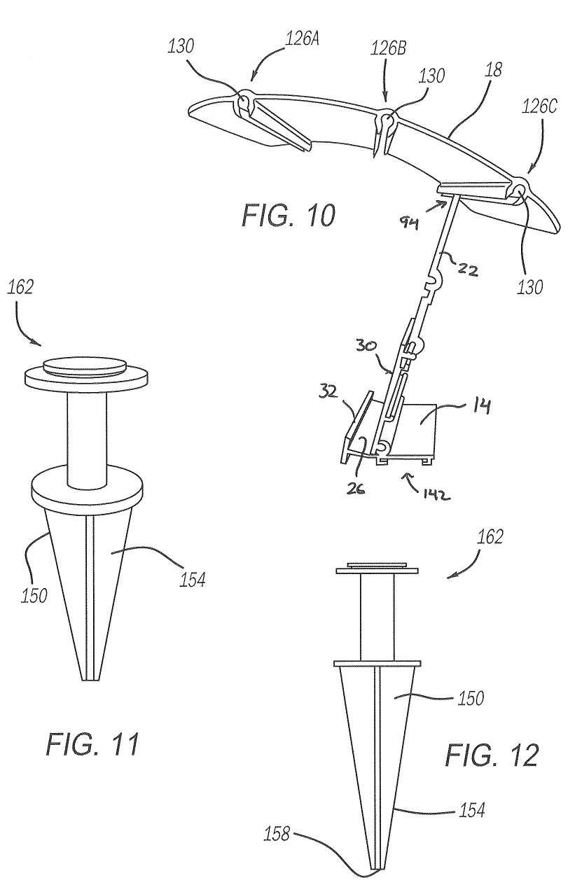

The fifth fastening element 114 is fittable into any one of the grooves 126A, 126B, 126C such that the wide portion 118 is within the wide portion 130 of one of the grooves 126A, 126B, 126C and the narrow portion 122 of the fifth fastening element 114 extends through the narrow portion 134 of one of the grooves 126A, 126B, 126C, thereby connecting the shade 18 to the post 22. The position of the shade 18 relative to the base 14 is determined by which of the fastening elements 126A, 126B, 126C the fifth fastening element 114 is engaged with. Thus, the position of the shade relative to the base 14 (and therefore the phone 42) is selectively variable. For example, in FIGS. 1, 16, and 17, the fastening element 114 is engaged with fastening element 126B. In FIG. 10, the fastening element 114 is engaged with fastening element 126C.

Accordingly, a user may thus adjust the position of the shade 18 relative to the base 14 to compensate for the position of the sun to ensure that the shade 18 blocks direct sunlight to the mobile phone 42. It should be noted that the shade 18 may have a shape other than the one shown within the scope of the claimed invention. For example, the shade 18 may form a portion of a sphere or dome within the scope of the claimed invention. Furthermore, other means of making the position of the shade 18 movable relative to the base 14 may be employed within the scope of the claimed invention. For example, instead of fastening element 114 and fastening elements 126A, 126B, 126C, a ball joint or other joint may interconnect the post 22 and the shade 18 such that the shade 18 is pivotable relative to the post 22 and the base 14.

The base 14 includes structure that defines an interface 142 as which support implements are attachable to the base. In the embodiment depicted, the interface 142 defines a slot 146 into which structure on an implement is insertable to retain the implement to the base 14. FIGS. 11 and 12 depict one implement that is engageable with the interface 142, namely, a stake 150 that has a tapered portion 154 that terminates at a point 158. The stake 150 also includes an interface 162 that is insertable into the slot 146 as shown in FIG. 17.

The stake 150 is insertable into the ground 152 (such as soil or sand) such that the stake 152 supports the base 14 above the surface of the ground 152 and isolates the phone 42 from the ground 152. FIG. 16 depicts another implement, namely a clip 166, that is engaged with the interface 142 in the same manner as the stake 150. The clip 166 enables a user to attach the base 14 to a tray, table, etc.

Other support implements (not shown) may also be attachable to the base 14 at the interface 142 within the scope of the claimed invention. For example, and within the scope of the claimed invention, a support implement (not shown) may include an interface, such as the one shown at 162, attached to a cylindrical or frusto-conical portion that is insertable into a cupholder adjacent to a seat at a stadium, arena, etc. The cylindrical or frusto-conical portion interacts with the cupholder in a manner that prevents lateral movement of the support implement, and correspondingly, the base 14.

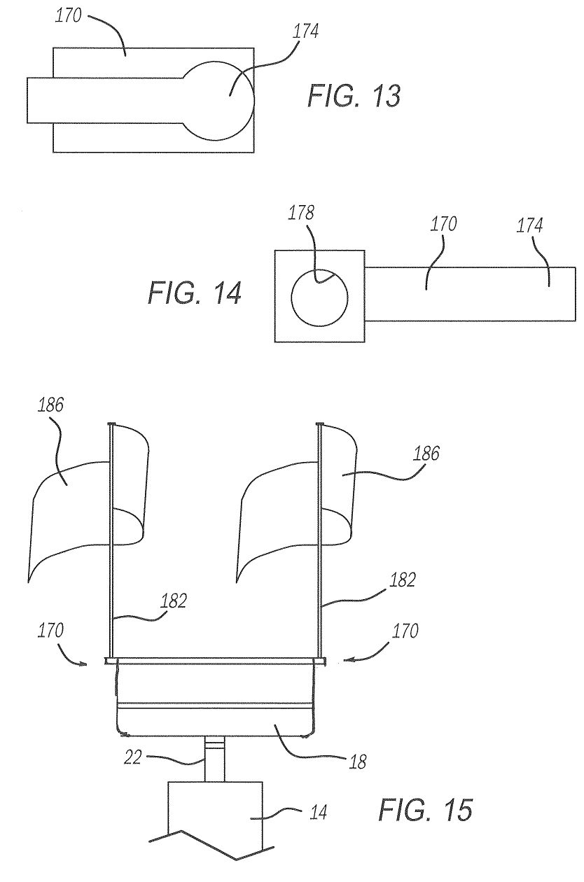

Referring to FIGS. 13 and 14, the assembly 10 may include flag holders 170. Each flag holder 170 has a segment 174 that is fittable within one of the grooves 126A, 126B, 126C (as shown in FIGS. 15 and 17), and includes structure defining an aperture 178 into which a small flagpole 182 is insertable to support a respective flag 186.

It should be noted that the fastening elements 114, 126A, 126B, 126C function in a similar manner as fastening elements 50, 54, 58, 62. It should be further noted that any fastening system may be employed within the scope of the claimed invention to connect the shade 18 to the post 22, to connect the post to the base 14, and to connect an implement 150 to the base 14.

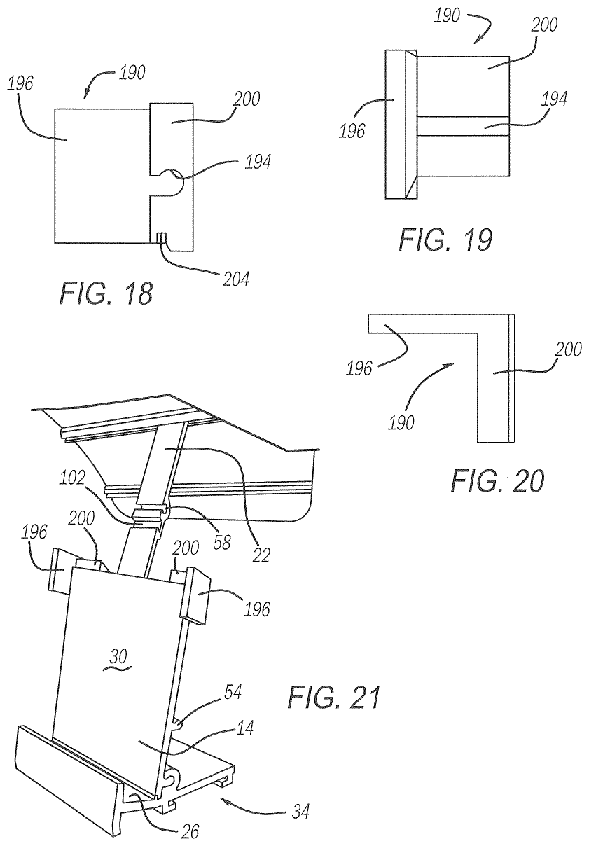

The assembly 10 may also include clips such as the one shown at 190 in FIGS. 18-20. Referring specifically to FIGS. 18-20, the clip 190 is substantially L-shaped and has a fastening element 194. The clip 190 has a first portion 196 and a second portion 200 that is perpendicular to the first portion 196. A groove 194 is formed in the second portion 200. The second portion 200 also defines a slot 204 in one edge.

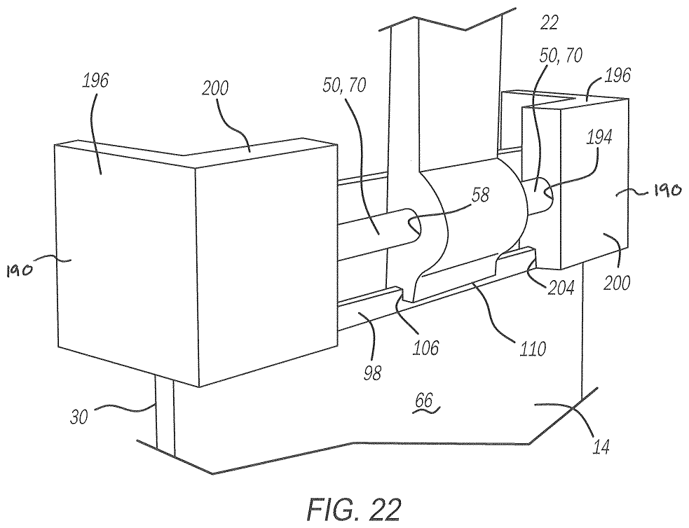

The groove 194 is a fastening element and has substantially the same cross-sectional shape as the fourth fastening element 62. Accordingly, the clip 190 is connectable to the base 14 by positioning the clip 190 so that the protuberance of fastening element 50 is within the groove 194 When the protuberance of the fastening element 50 is within the groove of fastening element 194, the distal portion of the lip 98 extends into the slot 204, as shown in FIG. 22.

Referring to FIGS. 21 and 22, a clip 190 may be installed on each end of the protuberance of fastening element 50 such that the first portion 196 of each clip 190 extends past surface 26 to retain a mobile phone that is leaning against surface 30.

While the best modes for carrying out the disclosure have been described in detail, those familiar with the art to which this disclosure relates will recognize various alternative designs and embodiments for practicing the disclosure within the scope of the appended claims.

1. A stand for supporting an electronic device with a screen, the stand comprising:
a base having a first surface, a second surface, and a portion that is restable on a planar horizontal surface;
wherein the first surface is generally horizontal and the second surface is generally vertical when the portion rests on the planar horizontal surface;
a post operatively connected to the base such that the post is generally vertical when the portion rests on the planar horizontal surface; and
a shade supported above the base by the post.

2. The stand of claim 1, wherein the base includes an interface at which a support implement is attachable to the base.

3. The stand of claim 2, wherein the support implement is a stake insertable into the ground.

4. The stand of claim 2, wherein the support implement is a clip.

5. The stand of claim 1, wherein the height of the post is selectively variable relative to the base.

6. The stand of claim 5, further comprising first and second fastening elements mounted to the base; and
a third fastening element mounted to the post and being engageable with both the first and second fastening elements.

7. The stand of claim 6, wherein the first and second fastening elements are protuberances having a respective wide portion and a respective narrow portion;
wherein the third fastening element is a groove having a wide portion and a narrow portion;
wherein the wide portions of the first and second fastening elements are fittable within the wide portion of the groove;
wherein the narrow portions of the first and second fastening elements are fittable through the narrow portion of the groove.

8. The stand of claim 1, further comprising a first fastening element mounted to the post;
a second fastening element mounted to the shade;
a third fastening element mounted to the shade; and
wherein the second and third fastening elements are engageable with the first fastening element to operatively connect the shade to the post.

9. The stand of claim 8, wherein the shade is curvilinear.

10. The stand of claim 9, wherein the shade is an annulus sector.

11. A method comprising:
possessing the stand of claim 1; and
placing the electronic device on the first surface such that the electronic device leans against the second surface.

12. The method of claim 11, further comprising adjust the height of the post relative to the base.

13. The method of claim 11, further comprising adjusting the position of the shade relative to the base.

14. The method of claim 11, wherein the base includes an interface at which a support implement is attachable to the base; and
wherein the method further includes attaching a support implement to the base at the interface.

15. The method of claim 14, wherein the support implement is a stake; and
wherein the method further comprises inserting the stake into the ground.
